(19) United States
(12) Patent Application Publication
(10) Pub. No.: US 2014/0358789 A1
(43) Pub. Date: Dec. 4, 2014

(54) ACQUIRER FACING FRAUD MANAGEMENT SYSTEM AND METHOD

(71) Applicants: B. Scott Boding, Mountain View, CA (US); Nathan Wood, Cambridge, MA (US); Michael McGirr, San Rafael, CA (US)

(72) Inventors: B. Scott Boding, Mountain View, CA (US); Nathan Wood, Cambridge, MA (US); Michael McGirr, San Rafael, CA (US)

(21) Appl. No.: 14/292,684

(22) Filed: May 30, 2014

Related U.S. Application Data
(60) Provisional application No. 61/829,149, filed on May 30, 2013.

(51) Int. Cl. G06Q 20/40

(52) U.S. Cl. CPC G06Q 20/4016
USPC 705/44

(57) ABSTRACT

Embodiments of the invention are directed to systems, apparatus, and methods for preventing merchant fraud by processing electronic payment transactions using acquirer rules. In some embodiments, a server computer can receive from an acquirer a rule to be applied to transactions conducted with a merchant. A plurality of authorization messages (e.g., request or response messages) can be received, each corresponding to a different transaction conducted with the merchant. An aggregate value can be calculated based on transaction data included in the authorization messages. It can be determined whether the aggregate value triggers the rule. If the rule is triggered, a transaction can be processed in accordance with a first protocol (e.g., by declining authorization or by withholding a settlement amount). If the rule is not triggered, the transaction can be processed in accordance with a second protocol (e.g., by proceeding with the transaction or releasing the full settlement amount).

### CROSS-REFERENCES TO RELATED APPLICATIONS

The present application is a non-provisional application of and claims priority to U.S. Provisional Application No. 61/829,149, filed on May 30, 2013, the entire contents of which are herein incorporated by reference for all purposes.

### BACKGROUND

Merchant fraud has become increasingly prevalent in the context of electronic payment transactions (e.g., transactions involving credit, debit, prepaid, or other electronic payment accounts). Such fraud may involve a merchant (e.g., an entity that sells goods and/or services) initiating fraudulent transactions using unauthorized payment accounts, selling illegal goods or services, establishing a sham storefront cross-linked with another merchant selling illegal goods or services, laundering money, etc.

To accept electronic payment methods, merchants generally must establish a relationship with an acquirer (e.g., a bank) that facilitates the exchange of authorization messages with issuers via payment processing networks and participates in settlement processes where funds are transferred from issuers to acquirers. Merchant fraud can be problematic to acquirers since fraudulent transactions may result in an acquirer being assessed a fine and/or being liable for all or part of the fraudulent transaction amount. Although existing fraud detection techniques exist, such techniques are focused on consumer fraud and are generally ineffective in detecting merchant fraud.

Embodiments of the present invention address these problems and other problems individually and collectively.

### BRIEF SUMMARY

Embodiments of the invention are directed to systems, apparatus, and methods for preventing merchant fraud by processing electronic payment transactions using acquirer rules. For example, an acquirer can provide a rule stating that a merchant transaction is to be declined if the merchant has attempted to obtain authorization of a threshold number of transactions (e.g., 100) in a given time interval (e.g., one hour), if the merchant has attempted to obtain authorization of transactions exceeding some amount in the aggregate (e.g., $1,000,000) in a given time interval (e.g., one day), and the like. In another example, an acquirer can provide a rule stating that only a certain amount of issuer approved transactions (e.g., $500,000) are to be released for settlement on a daily basis and that settlement of any remaining transactions is to be delayed for a predetermined period of time (e.g., one week) or until the acquirer can review and approve settlement. Such rules can provide acquirers with protection from the risks and liabilities associated with merchant fraud.

One embodiment of the invention is directed to a method. The method comprises receiving, by a server computer, a rule from an acquirer, the rule to be applied to transactions conducted with a merchant. A plurality of authorization messages can be received by the server computer, each of the plurality of authorization messages corresponding to a different transaction conducted with the merchant. The server computer can calculate an aggregate value based on transaction data included in the plurality of authorization messages. It can be determined whether the aggregate value triggers the rule. If the aggregate value triggers the rule, a transaction corresponding to an authorization message in the plurality of authorization messages can be processed in accordance with a first protocol. If the aggregate value does not trigger the rule, the transaction can be processed in accordance with the second protocol.

Another embodiment of the invention is directed to a server computer comprising a processor and a computer-readable medium coupled to the processor. The computer-readable medium can include code executable by a processor for performing a method. The method can comprise receiving a rule from an acquirer, the rule to be applied to transactions conducted with a merchant. A plurality of authorization messages can be received, each of the plurality of authorization messages corresponding to a different transaction conducted with the merchant. An aggregate value based on transaction data included in the plurality of authorization messages can be calculated. It can be determined whether the aggregate value triggers the rule. If the aggregate value triggers the rule, a transaction corresponding to an authorization message in the plurality of authorization messages can be processed in accordance with a first protocol. If the aggregate value does not trigger the rule, the transaction can be processed in accordance with the second protocol.

Another embodiment of the invention is directed to a method. The method comprises transmitting, by an acquirer computer, a rule to a server computer, the rule to be applied to transactions conducted with a merchant. The server computer can thereafter receive a plurality of authorization messages, each of the plurality of authorization messages corresponding to a different transaction conducted with the merchant, calculate an aggregate value based on transaction data included in the plurality of authorization messages, determine whether the aggregate value triggers the rule, if the aggregate value triggers the rule, process a transaction corresponding to an authorization message in the plurality of authorization messages in accordance with a first protocol and, if the aggregate value does not trigger the rule, process the transaction in accordance with a second protocol.

In some embodiments, the plurality of authorization request messages can be authorization request messages received from the merchant, and processing the transaction in accordance with the first protocol can comprise generating an authorization response message indicating that authorization of the transaction is declined and transmitting the authorization response message to the merchant. In such embodiments, processing the transaction in accordance with the second protocol can comprise transmitting the authorization request message to an issuer of the account used to conduct the transaction, receiving an authorization response message from the issuer indicating whether the transaction is authorized by the issuer, and transmitting the authorization response message to the merchant.

In some embodiments, the plurality of authorization messages can be authorization response messages received from issuers of accounts used to conduct the corresponding transactions, the plurality of authorization response messages indicating whether the corresponding transactions are authorized by the issuers. In such embodiments, processing the transaction in accordance with the first protocol can comprise generating a settlement message requesting that only a portion of funds associated with the corresponding transactions be transferred from the issuers to the acquirer, initiating the transfer of the portion of funds by transmitting the settlement message to a payment processing network, and determining at a later time whether to initiate a transfer of the remaining portion of the funds from one or more of the issuers to the acquirer. In such embodiments, processing the transaction in accordance with the second protocol can comprise generating a settlement message requesting that funds associated with the corresponding transactions be transferred from the issuers to the acquirers, and initiating the transfer of funds by transmitting the settlement message to a payment processing network.

These and other embodiments of the invention are described in detail below.

### BRIEF DESCRIPTION OF THE DRAWINGS

FIG. 1 illustrates a block diagram of an exemplary payment processing system in accordance with some embodiments.

FIG. 2 illustrates a block diagram of an exemplary gateway including a server computer in accordance with some embodiments.

FIG. 3 shows a flowchart illustrating an exemplary method of processing payment transactions using acquirer rules in accordance with some embodiments.

FIG. 4 shows a flowchart illustrating an exemplary method of processing authorization request messages using acquirer rules in accordance with some embodiments.

FIG. 5 shows a system and corresponding workflow for processing authorization request messages using acquirer rules in accordance with some embodiments.

FIG. 6 shows a flowchart illustrating an exemplary method of processing authorization response messages using acquirer rules in accordance with some embodiments.

FIG. 7 shows a system and corresponding workflow for processing authorization response message using acquirer rules in accordance with some embodiments.

FIG. 8 illustrates a block diagram of an exemplary computer apparatus.

### DEFINITIONS

Prior to discussing embodiments of the invention, a further description of some terms may be helpful in understanding embodiments of the invention.

A “server computer” may include any suitable computer that can provide communications to other computers and receive communications from other computers. A server computer may include a computer or cluster of computers. For instance, a server computer can be a mainframe, a minicomputer cluster, or a group of servers functioning as a unit. In one example, a server computer may be a database server coupled to a Web server. A server computer may be coupled to a database and may include any hardware, software, other logic, or combination of the preceding for servicing the requests from one or more client computers. A server computer may comprise one or more computational apparatuses and may use any of a variety of computing structures, arrangements, and compilations for servicing the requests from one or more client computers. Data transfer and other communications between components such as computers may occur via any suitable wired or wireless network, such as the Internet or private networks.

A “processor” may include hardware within a server computer (or other computing device) that carries out instructions embodied as code in a computer-readable medium. An exemplary processor may be a central processing unit (CPU). As used herein, a processor can include a single-core processor, a plurality of single-core processors, a multi-core processor, a plurality of multi-core processors, or any other suitable combination of hardware configured to perform arithmetical, logical, and/or input/output operations of a computing device.

An “authorization request message” may include an electronic message that is sent to a payment processing network and/or an issuer of a payment account to request authorization for a transaction. An authorization request message according to some embodiments may comply with ISO 8583, which is a standard for systems that exchange electronic transaction information associated with a payment made by a consumer using a payment device or payment account. The authorization request message may include an issuer account identifier that may be associated with a consumer payment device or payment account. An authorization request message may also comprise additional data elements corresponding to identification information including, by way of example only: a service code, a CVV/iCVV (card verification value), a dCVV (dynamic card verification value), a cryptogram (e.g., a unique cryptographic value for the transaction), an expiration date, etc. An authorization request message may also comprise transaction information, such as any information associated with a current transaction, such as the transaction amount, merchant identifier (e.g., MVV), merchant location, merchant category code, etc., as well as any other information that may be utilized in determining whether to authorize a transaction.

An “authorization response message” may include an electronic message reply to an authorization request message generated by an issuing financial institution or a payment processing network. An authorization response message according to some embodiments may comply with ISO 8583. An authorization response message may include, by way of example only, one or more of the following status indicators: Approval—transaction was approved; Decline—transaction was not approved; or Call Center—response pending more information, merchant must call the toll-free authorization phone number. The authorization may also include “identification information” as described above. The authorization response message may also include an authorization code, which may be a code that a credit card issuing bank returns in response to an authorization request message in an electronic message (either directly or through the payment processing network) to the merchant's access device (e.g., POS equipment) that indicates approval of the transaction. The code may serve as proof of authorization. As described below, in some embodiments, a payment processing network may generate or forward the authorization response message to a gateway, merchant, or an acquirer of the merchant.

A “settlement message” can include an electronic message used to initiate the transfer of funds from an issuer to an acquirer, the funds being associated with an electronic payment transaction conducted at a merchant having a relationship with the acquirer. A settlement message according to some embodiments may comply with ISO 8583. Settlement can be initiated by a merchant, acquirer, gateway, or other suitable payment processing entity. Settlement messages can be generated and transmitted to a payment processing network and/or issuer periodically (e.g., daily) or sporadically. In some embodiments, a payment processing network can facilitate the transmission of a settlement message and an exchange of funds. For instance, upon receipt of a settlement message, a payment processing network can transmit the settlement message to an issuer. Funds can be transferred from the issuer to a settlement account designated by the payment processing network which can direct the funds from the settlement account to the acquirer which may deposit the funds (minus any fees owed to the acquirer) in a merchant account.

A “rule” can include one or more criteria applied to electronic payment transactions. A rule can be provided by an acquirer and can be customizable. In some embodiments, a rule can be a “default rule” determined by a gateway (as described in further detail below) or other transaction processing entity. Rules can apply to transactions conducted with specific merchant and/or categories of merchants. Criteria can include threshold values for transaction volume, transaction amount, credit/reversal amount or volume, and the like, in a selected time interval. In some embodiments, such criteria can be established based on historical transaction data (e.g., moving averages) for specific merchants or merchant categories. Criteria can also relate to characteristics of individual transactions such as an indication of transaction type (e.g., e-commerce indicator (ECI), card present/not present), location, BIN, branding, account type, Internet Protocol (IP) address, and the like.

An “aggregate value” can include a value calculated based on transaction data corresponding to a plurality of merchant transactions. Aggregate values can include, but are not limited to, a sum of transaction amounts, a sum of transaction amounts in a selected time interval, a total transaction volume in a selected time interval, a sum of credit/reversal amounts, a sum of credit/reversal amounts in a selected time interval, a total credit/reversal volume in a selected time interval, or any other suitable aggregation of transaction data. As used herein, an “aggregate value triggering a rule” can include an aggregate value satisfying a criteria (e.g., meeting or exceeding a threshold) of a “rule” as defined above.

### DETAILED DESCRIPTION

Embodiments of the invention are directed to systems, apparatus, and methods for preventing merchant fraud by processing electronic payment transactions using acquirer rules. Merchants (e.g., online merchants) can engage in transactions with consumers using electronic payment methods (e.g., credit card accounts, debit accounts, prepaid accounts, and the like). To facilitate the exchange of authorization messages with issuers and the movement of funds from issuers, a merchant can utilize an acquirer (e.g., an acquiring bank). In the case of merchant fraud, an acquirer may be subject to fines or financial responsibility for all or a portion of the fraudulent transaction amount.

To mitigate this risk, in some embodiments, acquirers can establish various rules at a transaction gateway positioned (in a communicative sense) between merchants and issuers. Such rules can take into account historical transaction statistics to single out merchant transactions with a high probability of fraud. If an acquirer rule is triggered, a number of remedial measures can be taken by the gateway according to various embodiments. For example, if an authorization request message for a merchant transaction is received that triggers a rule, the gateway can reject the transaction without submitting the authorization request message to the issuer for authorization. As another example, if a rule is triggered by an issuer-authorized transaction, the gateway can delay settlement of all or a portion of the transaction amount until some predetermined period of time expires within which the transaction is not reported or otherwise deemed fraudulent, or until the acquirer reviews and approves settlement of the transaction.

As an illustration, an acquirer can establish a relationship with a merchant that specializes in the sale of a particular type of good. By analyzing historical transaction statistics for the merchant, the acquirer can determine an average transaction volume for a given time interval (e.g., 1000 transactions per day). Since uncharacteristically high transaction volume may be a general indicator of merchant fraud, the acquirer may not want the merchant's transactions approved if a threshold (e.g., 1,500 transactions) is met or exceeded on any given day. In some embodiments, the acquirer can establish such a rule at a transaction gateway positioned between the merchant and account issuers. For instance, an employee or representative of the acquirer can access a web-based dashboard of the gateway and set the threshold amount of 1,500 transactions per day for the particular merchant.

Going forward, the gateway can keep a running tally of the merchant's transactions since authorization request messages for such transactions are received at the gateway prior to forwarding to the appropriate issuers via a payment processing network. If an authorization request message is received for a transaction that causes the acquirer-provided rule to be triggered (i.e. that causes the transaction volume threshold to be met or exceeded), the gateway can reject the transaction instead of passing the authorization request message to the issuer for authorization. The gateway can generate an authorization response message indicating that the transaction has been declined, and can transmit the response to the merchant.

As another illustration, an acquirer may want protection from merchant fraud without outright rejecting transactions. In some embodiments, this can be accomplished by delaying settlement of the merchant's transactions. For instance, the acquirer can analyze the merchant's historical transaction data to identify the merchant's average sales volume (e.g., $100,000 per day). In this illustration, the acquirer can set a rule at the gateway (e.g., via the web-based dashboard) that causes settlement of transactions approved after the average sales volume has been met to be delayed for a specified period of time (e.g., three days) or until the acquirer approves settlement of the transaction.

At the end of the day, the gateway can calculate the sum of the merchant's transactions, and can initiate settlement of only transactions with an aggregated amount of $100,000 so that this amount is transferred from issuers to the acquirer and settlement of any additional transactions for the day can be delayed. If, upon expiration of the time period, the remaining transactions have not been reported (or otherwise determined to be) fraudulent, or if the acquirer reviews and approves settlement of the remaining transactions, the gateway can release the remaining transaction amount for settlement.

Embodiments of the invention can provide a number of advantages. Merchant fraud in the context of electronic payment transactions has become more common. When a merchant initiates a fraudulent transaction involving an unauthorized payment account (e.g., a stolen credit card number), a sham storefront, illegal goods, money laundering, etc., the merchant's acquirer may be subject to fines and/or liability for the amount of the fraudulent transaction. However, existing fraud detection techniques are focused on consumer fraud and generally ineffective in detecting merchant fraud. By allowing acquirers to establish rules that prevent questionable transactions from being authorized and/or settled, embodiments of the invention may reduce the incidence of merchant fraud thereby minimizing an acquirer's financial risk.

Further, in the context of e-commerce transactions, acquirers have generally been made aware of a transaction only during the settlement process where funds for the transaction are received by the acquirer after the transaction has been authorized by the issuer. In such an environment, if the merchant makes repeated attempts to conduct transactions using stolen account information, the issuer may decline the authorization requests. Since such transaction are not settled, the acquirer may be unaware that they have established a relationship with a fraudulent merchant. By monitoring a merchant's transactions and providing reports and alerts to the acquirer, embodiments of the invention may inform acquirers of fraudulent merchants so that the acquirer can terminate the relationship or, in some embodiments, establish more stringent fraud detection rules for the merchant's transactions.

### I. Example Transaction System and Process Flow

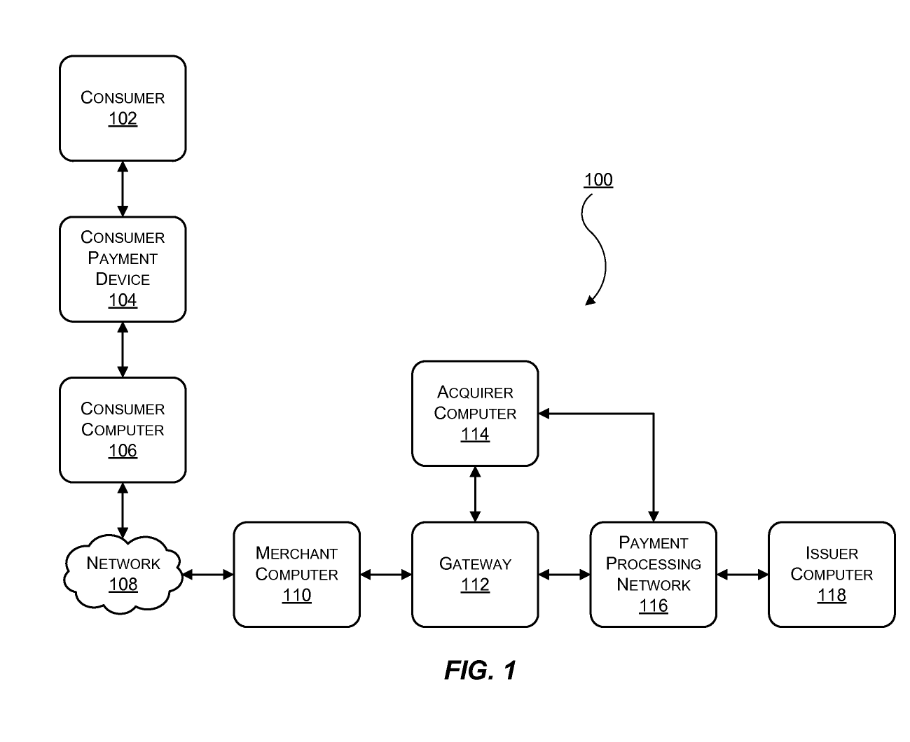

FIG. 1 illustrates a block diagram of an exemplary payment processing system 100 in accordance with some embodiments. Although some of the entities and components in the system 100 are depicted as separate, in some instances, one or more of the components may be combined into a single device or location. Similarly, although certain functionality may be described as being performed by a single entity or component within the system 100, the functionality may in some instances be performed by multiple components and/or entities. Communication between entities and components may comprise the exchange of data or information using electronic messages and any suitable electronic communication medium and method, as described below.

As illustrated in FIG. 1, the system 100 may include one or more consumers, consumer payment devices, consumer computers, networks, merchant computers, gateways, acquirer computers, payment processing networks, issuers computer, and/or any other suitable payment processing entities. For instance, as illustrated in FIG. 1, the system 100 can include a consumer 102 having a consumer payment device 104. The consumer 102 can be an individual, an organization such as a business, or any other suitable entity capable of purchasing goods and/or services using the consumer payment device 104.

The consumer payment device 104 can be in any suitable form. For instance, a suitable payment device can be hand-held and compact so that it can fit into a wallet and/or pocket (e.g., pocket-sized) of the consumer 102. Exemplary consumer payment devices may include, but are not limited to, smart cards, magnetic stripe cards, keychain devices (such as the Speedpass™ commercially available from Exxon-Mobil Corp.), smart media, transponders, 2-D barcodes, QR codes, and the like. If the consumer payment device 104 is in the form of a smartcard or other payment card (e.g., a debit card, credit card, prepaid card, gift card, and the like), the consumer payment device 104 may operate in a contact mode (e.g., using data stored on a magnetic stripe) and/or a contactless mode (e.g., using contactless circuitry and wireless communication such as NFC, Bluetooth, and the like).

The system 100 can further include a consumer computer 106 that may include an external communication interface (e.g., for communicating with a merchant computer 110 or other entity), system memory comprising one or more modules to generate and utilize electronic messages, and a data processor for facilitating a financial transaction conducted with a merchant operating the merchant computer 110. The consumer computer 106 can be any suitable computing device, including a stationary device (e.g., a desktop computer) or a mobile device such as a laptop computer, tablet computer, net book, mobile phone (e.g., a smartphone), and the like.

In some embodiments, the system 100 can further include the merchant computer 110 which may be operated by a merchant. As used herein, a “merchant” may refer to an entity that engages in transactions and that can sell goods and/or services to consumers. The merchant computer 110 can include an external communication interface (e.g., for communicating with the consumer computer 106, a gateway 112, or other entity), system memory comprising one or more modules to generate and utilize electronic messages, and a data processor for facilitating financial transactions and the exchange of electronic messages.

To conduct a purchase transaction, in some embodiments, the consumer 102 can use the consumer computer 106 to communicate with the merchant computer 110. Such a transaction may involve the consumer 102 using the consumer computer 106 to provide account information associated with the consumer payment device 104 to the merchant computer 110. For instance, the merchant computer 110 may host a merchant website that provides an interface for the consumer 102 to select goods and/or services for purchase and enter account information to pay for the purchase such as an account number, expiration date, CVV, and the like.

In some embodiments, the consumer computer 106 and the merchant computer 108 can communicate using a network 108 which may be any suitable communication network such as the Internet, a voice network, and/or a data network. Any suitable communication protocol can be used including, but not limited to, WiFi (IEEE 802.11 family standards), 3G, 4G EDGE, and the like.

The system 100 may further include an acquirer computer 114 operated by an acquirer. As used herein, an “acquirer” may refer to a business entity (e.g., a commercial bank or financial institution) that has a business relationship with a particular merchant or similar entity, and that facilitates clearing, settlement, and any other suitable aspect of electronic payment transactions. The acquirer computer 114 may include an external communication interface (e.g., for communicating with the merchant computer 110, the gateway 112, a payment processing network 116, or other entity), system memory comprising one or more modules to generate and utilize electronic messages, and a data processor for facilitating financial transactions and the exchange of electronic messages.

The system 100 may further include an issuer computer 118 operated by an issuer. As used herein, an “issuer” may refer to a business entity (e.g., a bank or other financial institution) that maintains financial accounts for consumers and that may issue payment accounts and consumer payment devices (e.g., credit cards, debit cards, and the like) used to access funds of such accounts. Some entities may perform both issuer and acquirer functions. The issuer computer 118 may include an external communication interface (e.g., for communicating with the payment processing network 116 or other entity), system memory comprising one or more modules to generate and utilize electronic messages, and a data processor for facilitating financial transactions and the exchange of electronic messages.

The system 100 may further include the payment processing network 116, which may include data processing subsystems, networks, and operations used to support and deliver authorization services, exception file services, and clearing and settlement services. For instance, the payment processing network 116 may comprise a server computer, coupled to a network interface (e.g. by an external communication interface), and a database(s) of information. An exemplary payment processing network may include VisaNet™. Payment processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services. The payment processing network 116 may include an external communication interface (e.g., for communicating with the gateway 112, the acquirer computer 114, the issuer computer 118, or other entity), system memory comprising one or more modules to generate and utilize electronic messages, and a data processor for facilitating financial transactions and the exchange of electronic messages.

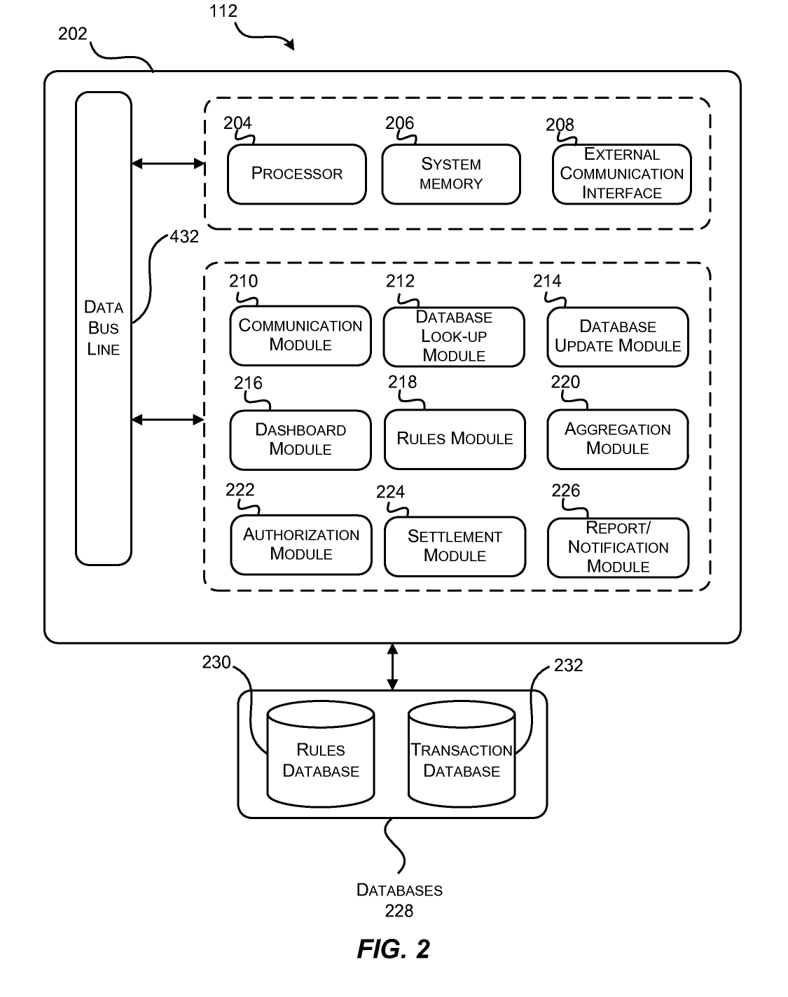

As shown in FIG. 1, the system 100 can further include the gateway 112. As used herein, a “gateway” can be any entity that provides services in support of electronic payment transactions. In some embodiments, as described in further detail below, such services can include detecting merchant fraud using rules provided by acquirers and/or default rules. The gateway 112 may include an external communication interface (e.g., for communicating with the merchant computer 110, the acquirer computer 114, the payment processing network 116, the issuer computer 118, or other entity), system memory comprising one or more modules to generate and utilize electronic messages, and a data processor for facilitating financial transactions and the exchange of electronic messages. The components of the gateway 112, according to some embodiments, are described in further detail below with reference to FIG. 2.

In some embodiments, the gateway 112 may provide additional services such as a hosted order page and/or silent order post. As used herein, a “hosted order page” (HOP) can be a third-party hosted webpage that accepts payment information from consumers (e.g., the consumer 102) on behalf of merchants (e.g., the merchant operating merchant computer 110). In some embodiments, the merchant's website may redirect a consumer to a HOP on a domain/server of the gateway 112 when the consumer selects a ‘Buy’ or ‘Checkout’ button from an online shopping cart. Once at the HOP, the consumer can input payment information (e.g., information associated with the consumer payment device 104), such as credit card information. The gateway 112 can use the payment information entered by the consumer to process the payment transaction for the merchant so that the merchant can avoid handling the consumer's payment information, and thereby avoid the cost and effort of complying with the Payment Card Industry Data Security Standard (PCI DSS) and government regulations regarding storing sensitive payment information. As used herein, a “silent order post” (SOP) may be akin to a HOP but with only the sensitive textboxes and other input controls being hosted by the gateway 112. That is, the merchant can host the order page but the sensitive fields, such as the credit card number and expiration date entry textboxes, can be posted only at the gateway 112.

Many of the data processing functions and features of some embodiments of the invention may be present in the gateway 112 (and a server computer therein). It should be understood, however, that such functions and features could be present in other components of the system 100 in some embodiments, and need not be present in the gateway 112, or a server computer therein.

The consumer computer 106, merchant computer 110, gateway 112, acquirer computer 114, payment processing network 116, and issuer computer 116 may all be in operative communication with each other. For instance, as described above, some or all of these components of the system 100 can include an external communication interface. As used herein, an “external communication interface” may refer to any hardware and/or software that enables data to be transferred between two or more components of the system 100 (e.g., between devices residing at locations such as an issuer, acquirer, merchant, or payment processing network, etc.). Some examples of external communication interfaces may include a modem, a network interface (such as an Ethernet card), a communications port, a Personal Computer Memory Card International Association (PCMCIA) slot and card, and the like. Data transferred via an external communications interface may be in the form of signals which may be electrical, electromagnetic, optical, or any other signal capable of being received by the external communications interface (collectively referred to as “electronic signals” or “electronic messages”). These electronic messages that may comprise data or instructions may be provided between one or more of the external communications interface via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable method.

As would be understood by one of ordinary skill in the art, any suitable communications protocol for storing, representing, and transmitting data between components of the system 100 may be used. Some examples of such methods may include utilizing predefined and static fields (such as in core TCP/IP protocols); “Field: Value” pairs (e.g., HTTP, FTP, SMTP, POP3, and SIP); an XML based format; and/or Tag-Length-Value format.

As described above, the system 100 can facilitate an electronic commerce (e-commerce) transaction where, for instance, the consumer 102 purchases goods and/or services using a merchant website hosted by the merchant computer 110 and accessible via the network 108 using the consumer computer 106. In some other embodiments, the system 100 can also facilitate a “card present” transaction where the consumer 102 makes a purchase in-person at a merchant location (e.g., a store, restaurant, hotel, or any other suitable retail establishment). In such embodiments, the merchant computer 110 can include (or be coupled to) a merchant access device. Exemplary merchant access devices may include point of sale (POS) devices (stationary and mobile), mobile phones (e.g., smartphones), PDAs, desktop computers, laptop computers, tablet computers, handheld specialized readers, set-top boxes, electronic cash registers (ECRs), automated teller machines (ATMs), kiosks, and the like. A merchant access device can use any suitable contact or contactless mode of operation to send or receive date from, or associated with, consumer payment devices (e.g., the consumer payment device 104). In some embodiments, a merchant access device may include a reader including one or more of radio frequency (RF) antennas, optical scanners, bar code readers, QR code readers, and magnetic stripe readers to interact with a consumer payment device such as the consumer payment device 104.

In some embodiments, the consumer payment device 104 can be a mobile device such as a mobile phone (e.g., smart phone), tablet computer, PDA, net book, laptop computer, media player, or the like. A mobile device may facilitate an “electronic” or “digital wallet” that may be used to conduct an electronic payment transaction. In such embodiments, an electronic wallet server (not shown) may be in operational communication with the merchant computer 110, gateway 112, payment processing network 116, and/or other entity, and may maintain an association between the consumer's digital wallet and one or more payment accounts (e.g., credit, debit, prepaid accounts, and the like). An electronic wallet server can provide a web interface (e.g. through one or more web pages) to receive and transmit requests for payment services and/or may provide an application program interface (API) on the consumer payment device 104 to provide the web service. A digital wallet can be utilized in both e-commerce and card present transaction environments.

A description of a typical electronic transaction flow using the system 100 may be helpful in understanding embodiments of the invention. As an initial step, the consumer 102 can attempt to purchase goods and/or services from a merchant. In the context of an e-commerce transaction, this may involve the consumer 102 selecting the items to purchase from a website hosted by the merchant computer 110 accessible via the network 108 using the consumer computer 106. The consumer can enter payment information (e.g., an account number, expiration date, CVV, etc.) on the merchant website or, in some embodiments, a HOP or SOP hosted by the gateway 112. In some embodiments, the payment information can already be stored in a database (e.g., a “cards-on-file database) accessible to the merchant computer 110 (or gateway 112).

The merchant computer 110 can then generate an authorization request message for the transaction, and can transmit this message to the gateway 112. The gateway 112 can then transmit the authorization request message 118 to the payment processing network 116 which may forward the message to the issuer computer 118 operated by the issuer of the account associated with the consumer payment device 104.

Upon receipt of the authorization request message, the issuer computer 118 can perform a number of processes (e.g., verifying the account, confirming that the account has a sufficient balance or available credit to cover the amount of the transaction, consumer fraud detection, and/or other processes) to determine whether to authorize the transaction. An authorization response message is then generated by the issuer computer 118 including an indication of the authorization decision, and transmitted by the issuer computer 118 to the gateway 112 via the payment processing network 116. The gateway 112 stores a record of the authorization decision and then forwards the authorization response message to the merchant computer 110. The merchant computer 110 may then provide an indication to the consumer 102 whether authorization of the transaction has been approved or declined by the issuer. In some embodiments, this may involve displaying an indication of the authorization decision on the consumer computer 106 connected to the merchant's website via the network 108.

At the end of the day, if the transaction was authorized by the issuer, a clearing and settlement process can be conducted by the gateway 112. A clearing process may include the exchange of financial details between the acquirer computer 114 and the issuer computer 118 across the payment processing network 116 to facilitate posting to the consumer's account and reconciliation of the settlement position. A settlement process may include the actual transfer of funds from the issuer computer 118 to the acquirer computer 114. In some embodiments, to initiate settlement, the gateway can transmit a settlement file including the an approval code for the transaction (along with other approved transactions in a batch format) to the payment processing network 116 which can then communicate with the issuer computer 118 and the acquirer computer 114 to facilitate the transfer of funds.

### II. Example Gateway

FIG. 2 illustrates a block diagram of an exemplary gateway 112 including a server computer 202 in accordance with some embodiments. The exemplary server computer 202 is illustrated as comprising a plurality of hardware and software modules (204-226). However, it should be appreciated that this is provided for illustration purposes only, and each of the modules and associated functionality may be provided and/or performed by the same or different components. That is, the server computer 202 may, for instance, perform some of the relevant functions and steps described herein with reference to the gateway 112 through the use of any suitable combination of software instructions and/or hardware configurations. It should be noted that although FIG. 2 illustrates all of the modules located on a single device, the disclosure is not meant to be so limited. Moreover, a system for implementing the functionality described herein may have additional components or less then all of these components. Additionally, some modules may be located on other devices such as a remote server or other local devices that are functionally connected to the server computer component(s).

The server computer 202 is shown as comprising a processor 204, system memory 206 (which may comprise any combination of volatile and/or non-volatile memory such as, for example, buffer memory, RAM, DRAM, ROM, flash, or any other suitable memory device), and an external communication interface 208. Moreover, one or more of the modules 210-226 may be disposed within one or more of the components of the system memory 206, or may be disposed externally. As was noted above, the software and hardware modules shown in FIG. 2 are provided for illustration purposes only, and the configurations are not intended to be limiting. The processor 204, system memory 206 and/or external communication interface 208 may be used in conjunction with any of the modules described below to provide a desired functionality. Some exemplary modules and related functionality may be as follows:

A communication module 210 may be configured or programmed to perform some or all of the functionality associated with receiving, sending, and generating electronic messages for transmission through the system 100 to or from any of the entities shown in FIG. 1. When an electronic message is received by the server computer 200 via the external communication interface 208, it may be passed to the communications module 210. The communications module 210 may identify and parse the relevant data based on a particular messaging protocol used in the system 100. The received information may comprise, for instance, identification information, transaction information, and/or any other information that the gateway 112 may utilize in processing an electronic payment transaction. The communication module 210 may then transmit any received information to an appropriate module within the server computer 202 (e.g., via a system bus line 232). The communication module 210 may also receive information from one or more of the modules in the server computer 202 and generate an electronic message in an appropriate data format in conformance with a transmission protocol used in the system 100 so that the message may be sent to one or more components within the system 100 (e.g., to the payment processing network 116, merchant computer 110, or other entity). The electronic message may then be passed to the external communication interface 208 for transmission. The electronic message may, for example, comprise an authorization request message (e.g., to be transmitted to the issuer computer 118 via the payment processing network 116), an authorization response message (e.g., to be transmitted to the merchant computer 110), a settlement message (e.g., to be transmitted to the payment processing network 116), or any other suitable electronic message used in the context of an electronic payment transaction.

A database look-up module 212 may be programmed or configured to perform some or all of the functionality associated with retrieving information from one or more databases 228. In this regard, the database look-up module 212 may receive requests from one or more of the modules of the server computer 202 for information that may be stored in one or more of the databases 228. The database look-up module 212 may then determine and query an appropriate database.

A database update module 212 may be programmed or configured to provide some or all of the functionality associate with maintaining and updating the databases 228, such as a rules database 230 and a transaction database 232. In this regard, the database update module 212 may receive information such as rules (e.g., from acquirers), transaction information (e.g., authorization request and response messages), and other information from one or more of the modules described herein. Such information may then be stored in the appropriate location in the databases 228 using any suitable storage process.

A dashboard module 216 may be programmed or configured to provide some or all of the functionality associated with providing an interface for acquirers to provide rules and receive reports and/or alerts. In some embodiments, the dashboard module 216 may provide a web-based interface. The dashboard module 216 may provide rules to the database update module 214 which may store the rules in the rules database 230, and may receive reports and/or alerts from a report/notification module 226.

A rules module 218 may be programmed or configured to perform some or all of the functionality associated with applying acquirer-provided rules to merchant transactions. In some embodiments, the rules module 218 can apply default rules created by the gateway 112 or other component of the system 100. In some embodiments, the rules module 218 may apply a rule to a plurality (e.g., an aggregation) of transactions and, in some embodiments, the rules module 218 may apply a rule to individual transactions. The rules module may retrieve a rule from the rules database 230 using the database look-up module 212. Application of a rule may be triggered by receipt of an authorization request message, an authorization response message, a clearing message, a settlement message, a scheduled time, expiration of a predetermine period of time, or any other suitable triggering event according to various embodiments of the invention.

An aggregation module 220 may be programmed or configured to perform some or all of the functionality associated with calculating aggregate values based on aggregated transaction data. For instance, the aggregation module may retrieve information about authorization request messages, authorization response messages, issuer approvals/declines, returns, credits, and other information for a plurality of merchant transactions from the transaction database 232 (e.g., using the database look-up module 212). The aggregation module 220 may calculate an aggregate value based on this transaction information. In some embodiments, the aggregation module 220 can retrieve transactions data and calculate an aggregate value for transactions conducted in a defined time interval. The aggregation module may also calculate moving averages and other statistics based on the transaction data.

An authorization module 222 may be configured or programmed to perform some or all the functionality associated with processing and generating authorization messages. For instance, the authorization module 222 may receive authorization response messages for merchant transactions from the merchant computer 110 and may forward such messages to the issuer computer 118 via the payment processing network 116. The authorization module 222 may also receive authorization response messages for merchant transactions from the issuer computer 118 via the payment processing network, and may forward such messages to the merchant computer 110. In some embodiments, as described in further detail below, the authorization module 222 may generate an authorization response message (e.g., a decline) and transmit the message to the merchant computer 110. The communication module 210 and external communication interface 208 may be utilized by the authorization module 222 to send and receive authorization messages. The authorization module 222 may store authorization messages (or a record of authorization messages) and other transaction information in the transaction database 232 (e.g., using the database update module 214).

A settlement module 224 may be programmed or configured to perform some or all the functionality associated with processing, generating, and transmitting settlement messages. For instance, the settlement module 224 may generate a settlement message for a merchant's transactions (e.g., for the merchant operating the merchant computer 110), and may transmit the message to the payment processing network 116 so that it can be forwarded to the issuers associated with the merchant's transactions (e.g., to the issuer computer 118 and to devices operated by other issuers of accounts used to conduct transactions at the merchant). In some embodiments, the settlement module 224 can generate and transmit settlement messages periodically (e.g., daily) in a batch format such that a plurality of the merchant's transaction are settled. In some embodiments, the settlement module 224 may retrieve information about approved transactions from the transaction database 232 (e.g., using the database look-up module 212) to determine which transactions to include in a settlement message. In some other embodiments, the settlement module 224 may receive the settlement message from a merchant (e.g., from the merchant computer 110) and may forward the message to the payment processing network 116. As described in further detail below, in some embodiments, the settlement module 224 can generate a settlement message for only a portion of a merchant's transactions such that settlement of the remaining portion of the merchant's transactions is delayed. The communication module 210 and external communication interface 208 may be utilized by the settlement module 224 to send and receive settlement messages.

A report/notification module 226 may be programmed or configured to perform some or all of the functionality associated with generating and transmitting reports and notifications. As described in further detail below, reports and notifications can be transmitted to acquirers (e.g., the acquirer computer 114) or other transaction processing entity such as the merchant computer 110, payment processing network 116, etc. The communication module 210 and external communication interface 208 may be utilized by the report/notification module 226 to transmit reports and notifications. In some embodiments, the report/notification module 226 may transmit reports and/or alerts to the dashboard module 216 which may provide an interface for an acquirer or other entity to view the reports and/or alerts.

The gateway 112 may include one or more databases 228, such as rules database 230 and transaction database 232. Each of the databases shown in this example may comprise more than one database, and may be located in the same location or at different locations. The rules database 230 may contain information related to rules to be applied by the gateway 112 to merchant transactions. As described in further detail below, the rules stored in the rules database 230 may be provided by acquirers and may include any criteria suitable for detecting (or reducing the incidence of) merchant fraud. In some embodiments, the rules stored in the rules database 230 can be default rules created by the gateway (e.g., the rules module 218) or other entity of the system 100. For electronic transactions that pass through the gateway 112, transaction data can be stored in the transaction database 232, including information about authorization request messages, authorization response messages, issuer approvals/declines, returns, credits, and other information.

In FIG. 2, the server computer 202 is illustrated as comprising part of the gateway 112. This, however, is not intended to be limiting. In some embodiments, one or more of the modules 204-226 and databases 228 comprise any other suitable entity of the system 100. For instance, in some embodiments, one or more functionalities associated with the gateway 112 described herein may be performed by the payment processing network 116, issuer computer 118, acquirer computer 114, or other suitable entity.

### III. Aggregate Values and Rules

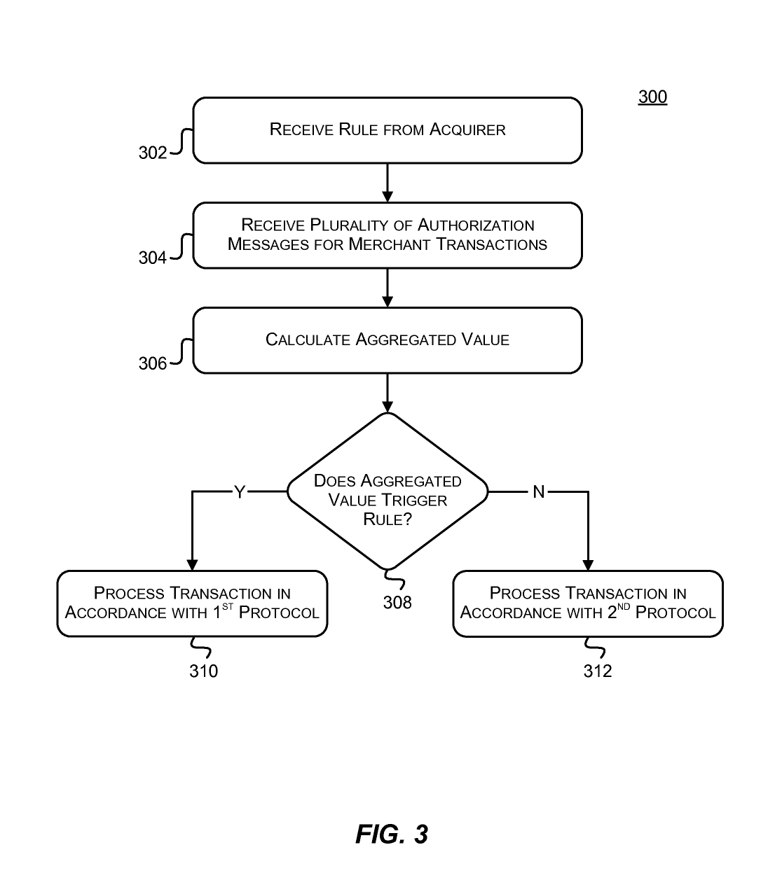

FIGS. 3-4 and 6 show flowcharts illustrating methods 300, 400, and 600 in accordance with some embodiments. The steps of methods 300, 400, and 600 may be performed by the server computer 202 of the gateway 112. In other embodiments, one or more of the steps may be performed by any other payment processing entity in the system 100. In some embodiments, one or more steps may be performed by entities not shown in FIG. 1, such as a merchant processor, acquirer processor, issuer processor, or other suitable entity.

FIG. 3 shows a flowchart illustrating an exemplary method 300 of processing payment transactions using acquirer rules in accordance with some embodiments.

In FIG. 3, at step 302, a server computer receives a rule from an acquirer, the rule to be applied to transactions conducted with a merchant. For instance, the server computer 202 of gateway 112 can receive a rule from the acquirer computer 114 to be applied to transactions conducted with the merchant computer 110. In some embodiments, the acquirer can provide the rule using an interface such as a web-based dashboard.

As described in further detail below, the rule can include any criteria suitable for detecting or otherwise reducing the incidence of merchant fraud. In some embodiments, the rule received from the acquirer is to be applied to transactions conducted with a particular merchant. In some embodiments, the rule received from the acquirer is to be applied to transactions conducted with a specified category of merchants (e.g., gas stations, grocery stores, airlines, hotels, etc.), the merchant being included in the specified category. For instance, one of the criteria of the rule can be a merchant category code (MCC) which is generally a four-digit number assigned to a merchant by a payment processing network when the merchant begins to accept electronic methods of payment such as credit cards, debit cards, and the like. Generally, a MCC may classify a merchant by the type of goods or services it provides. Some merchants (e.g., large merchants that sell many types of goods and/or services) may be assigned a plurality of MCCs.

In some embodiments, as described in further detail below, the rule can include criteria that relates to a plurality of transactions such as a sum of transaction amounts, a sum of transaction amounts in a specified time interval, a number of transactions in a specified time interval, and other criteria. The methods described herein include applying rules to aggregated transaction data associated with a plurality of merchant transactions. In some embodiments, however, an acquirer-provided rule can include criteria that relates to characteristics of individual transactions such as an indication of transaction type (e.g., e-commerce indicator (ECI), card present/not present), location, BIN, branding, account type, Internet Protocol (IP) address, and the like.

At step 304, the server computer receives a plurality of authorization messages, each of the plurality of authorization messages corresponding to a different transaction conducted with the merchant. In some embodiments, the plurality of authorization messages are authorization request messages received from the merchant. In some other embodiments, the plurality of authorization messages are authorization response messages received from issuers of accounts used to conduct the corresponding transactions, the plurality of authorization response messages indicating whether the corresponding transactions are authorized by the issuer. For instance, the server computer 202 of gateway 112 can receive a plurality of authorization request messages for multiple transactions from the merchant computer 110 over a period of time, and/or can receive a plurality of authorization response messages from the issuer computer 118 (and from other issuers in some embodiments) over a period of time via the payment processing network 116.

At step 306, the server computer calculates an aggregate value based on transaction data included in the plurality of authorization messages. In some embodiments, the aggregate value includes a sum of transaction amounts, a sum of transaction amounts in a time interval, and/or a number of transactions in a time interval. For instance, the server computer 202 of gateway 112 can retrieve transaction data from the transaction database 230 for a plurality of authorization messages corresponding to transactions attempted by the merchant, and can calculate a value based on an aggregation of the transaction data.

At decision 308, the server computer determines whether the aggregate value triggers the rule. For instance, the server computer 202 of gateway 112 can compare the calculated aggregate value to criteria included in the rule to determine whether the rule is triggered. If the rule is triggered, the method 300 can proceed to step 310.

At step 310, a transaction corresponding to an authorization message in the plurality of authorization messages is processed in accordance with a first protocol. For instance, the server computer 202 of gateway 112 can process the transaction in accordance with a first set of processes. In some embodiments, the first protocol may include processes designed to detect or otherwise reduce the incidence of merchant fraud. As described in further detail below with respect to methods 400 and 600, the first protocol may include transmitting an authorization response message declining the transaction to the merchant, or may include transmitting a settlement message to initiate the transfer of only a portion of funds associated with the plurality of merchant transactions from the issuer to the acquirer. If, however, the rule is not triggered at decision 308, the method 300 can instead proceed to step 312.

At step 312, the transaction is processed in accordance with a second protocol. For instance, the server computer 202 of gateway 112 can process the transaction in accordance with a second set of processes that are different than the first set of processes. In some embodiments, the second protocol may include processes suitable for handling transactions associated with a low risk of merchant fraud. As described in further detail below with respect to methods 400 and 600, the second protocol may include transmitting the authorization request message to an issuer for authorization of the transaction, or may include transmitting a settlement message to initiate the transfer of the funds (e.g., the total amount) associated with the plurality of merchant transactions from the issuer to the acquirer.

A. Processing Authorization Request Messages Using Acquirer Rules

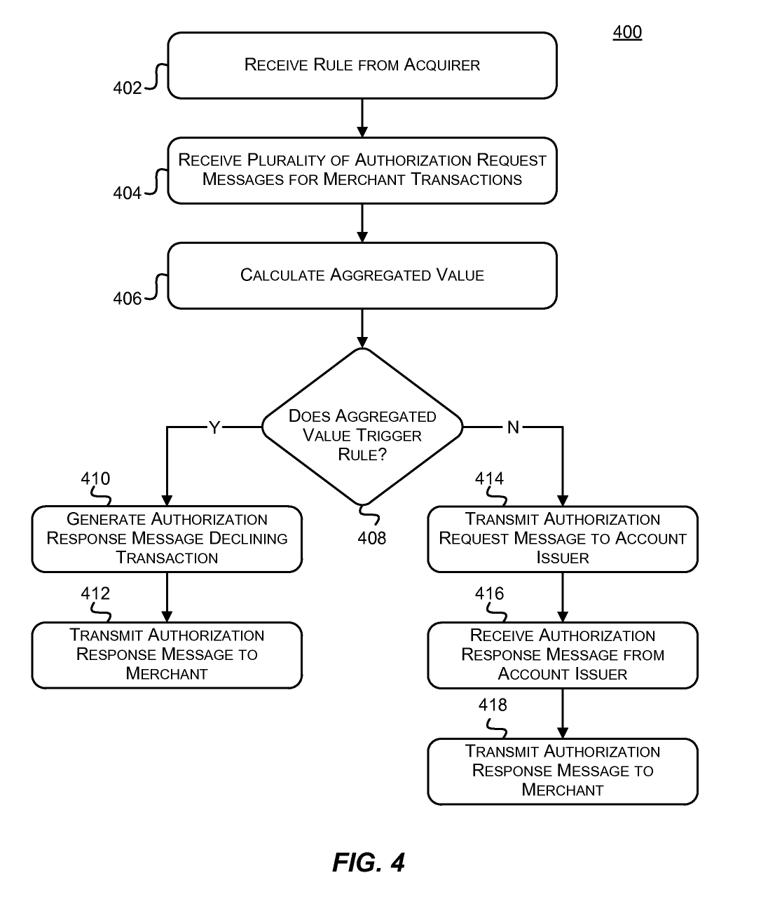

As described above, in some embodiments, the plurality of authorization messages received by the server computer can be authorization request messages received from the merchant. FIG. 4 shows a flowchart illustrating an exemplary method 400 of processing authorization request messages using acquirer rules in accordance with some embodiments.

In FIG. 4, at step 402, a server computer receives a rule from an acquirer, the rule to be applied to transactions conducted with a merchant. For instance, the server computer 202 of gateway 112 can receive a rule from the acquirer computer 114 to be applied to transactions conducted with the merchant computer 110. In some embodiments, the acquirer can provide the rule using an interface such as a web-based dashboard. The rule may include criteria that, if met, result in a transaction being rejected in lieu of forwarding the corresponding authorization request message to the issuer for authorization of the transaction.

As described above in regard to step 302 of method 300, the rule can include any criteria suitable for detecting or otherwise reducing the incidence of merchant fraud. In some embodiments, the rules received from the acquirer is to be applied to transactions specifically conducted with the merchant. In some embodiments, the rule received from the acquirer is to be applied to transactions conducted with a specified category of merchants (e.g., an MCC classification of merchants), the merchant being included in the specified category. The rule can include criteria that relates to a plurality (e.g., an aggregation) of transactions or, in some embodiments, to characteristics of individual transactions.

At step 404, the server computer receives a plurality of authorization request messages, each of the plurality of authorization request messages corresponding to a different transaction conducted with the merchant, the authorization request messages being received from the merchant. For instance, the server computer 202 of gateway 112 can receive a plurality of authorization request messages for multiple transactions from the merchant computer 110 over a period of time.

At step 406, the server computer calculates an aggregate value based on transaction data included in the plurality of authorization request messages. In some embodiments, the aggregate value includes a sum of transaction amounts, a sum of transaction amounts in a time interval, and/or a number of transactions in a time interval. For instance, the server computer 202 of gateway 112 can retrieve transaction data from the transaction database 230 for a plurality of authorization request messages corresponding to transactions attempted by the merchant, and can calculate a value based on an aggregation of the transaction data.

At decision 408, the server computer determines whether the aggregate value triggers the rule. For instance, the server computer 202 of gateway 112 can compare the calculated aggregate value to criteria included in the rule to determine whether the rule is triggered. If the rule is triggered, the method 400 can proceed to step 410 where a transaction corresponding to an authorization request message in the plurality of authorization request messages is processed in accordance with a first protocol.

At step 410, in accordance with the first protocol, an authorization response message is generated, the authorization response message indicating that authorization of the transaction is declined. For instance, in response to receiving an authorization request message from the merchant computer 110 that caused the acquirer-provided rule to be triggered, the server computer 202 of gateway 112 can generate an authorization response message declining or otherwise canceling the transaction.

At step 412, the authorization response message is transmitted to the merchant, thereby informing the merchant that the transaction is declined. For instance, the server computer 202 of gateway 112 can transmit the generated authorization response message to the merchant computer 110. If, however, the rule is not triggered at decision 408, the method 400 can instead proceed to step 414 where the transaction is processed in accordance with a second protocol.

At step 414, in accordance with the second protocol, the authorization received from the merchant is transmitted to an issuer of an account used to conduct the transaction. Since the rule was not triggered, the transaction is allowed to proceed with the issuer given an opportunity to provide final authorization of the transaction. For instance, at step 414, the server computer 202 of gateway 112 can forward the authorization request message received from the merchant computer 110 to the issuer computer 118 via the payment processing network 116.

At step 416, an authorization response is received from the issuer, the authorization response message indicating whether the transaction is authorized by the issuer. For instance, at step 416, the issuer computer 118 can determine whether to authorize the merchant transaction, and can transmit an authorization response message to the gateway 112 via the payment processing network 116, the message indicating the issuer's authorization decision.

At step 418, the authorization response message is transmitted to the merchant, thereby informing the merchant of the issuer's authorization decision. For instance, at step 418, the server computer 202 of gateway 112 can transmit the authorization response message received from the issuer computer 118 to the merchant computer 110.

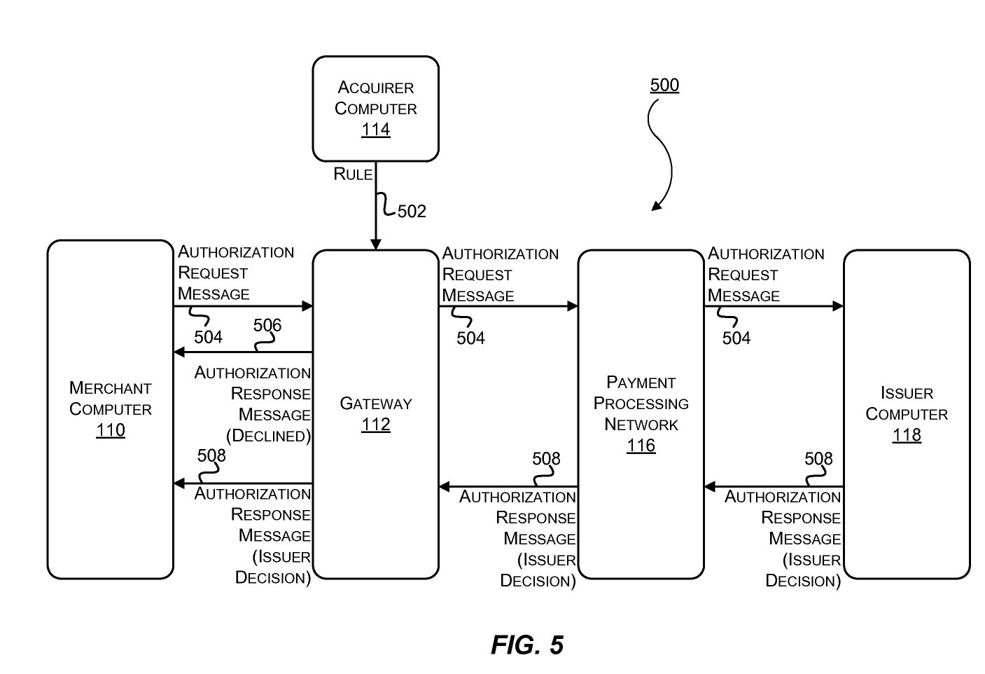

FIG. 5 shows a system 500 and corresponding workflow for processing authorization request messages using acquirer rules in accordance with some embodiments. As illustrated in FIG. 5, the system 500 may include components of the system 100 shown in FIG. 1, such as the merchant computer 110, gateway 112, payment processing network 116, issuer computer 118, and acquirer computer 114.

As a non-limiting illustration using the system 500 and workflow shown in FIG. 5, the acquirer using the acquirer computer 114 can transmit a message 502 including a rule to the gateway 112. In this illustration, based on the type of goods or services sold by the merchant and the merchant's average daily transaction volume, the acquirer-provided rule can include criteria stating that authorization request messages received from the merchant computer 110 are to be declined when the total number of authorization requests received in a given day exceeds 100,000 transactions.

At some point in time after receiving the rule from the acquirer computer 114, the gateway 112 may receive an authorization request message 504 from the merchant computer 110. Upon receipt, the gateway 112 can analyze the merchant's transaction history to calculate an aggregate value that reflects the total number of authorization request messages received from the merchant computer 110 that day, and can determine whether the aggregate value triggers the rule.

If the gateway 112 determines that the aggregate value (including the current authorization request message 204) is greater than 100,000 for the day, this will trigger the acquirer-provided rule that established 100,000 authorization request messages as the threshold allowed for the merchant computer 110. In this scenario, due to the risk of merchant fraud, the gateway 112 can transmit an authorization response message 506 to the merchant computer 110, the authorization response message indicating that the transaction is declined.

If, however, the gateway 112 determines that the aggregate value is less than or equal to 100,000, i.e. that the acquirer-provided rule has not been triggered, this may indicate a low risk of merchant fraud. In this scenario, the gateway 112 can instead allow the transaction to proceed by forwarding the authorization request message 504 to the issuer computer 118 via the payment processing network 116. The issuer computer 118 can make an authorization decision, and may transmit an authorization response message 508 indicating the decision to the gateway 112 via the payment processing network 116. The gateway 112 can then forward the authorization response message 508 including the issuer's authorization decision to the merchant computer 110.

Accordingly, when an acquirer-provided rule is triggered, the gateway 112 can prevent the transaction from proceeding altogether by immediately rejecting the authorization request message. The probability of the issuer computer 118 authorizing a transaction associated with merchant fraud and transferring the fraudulent funds to the acquirer computer 114 is thereby reduced.

B. Processing Authorization Response Messages Using Acquirer Rules

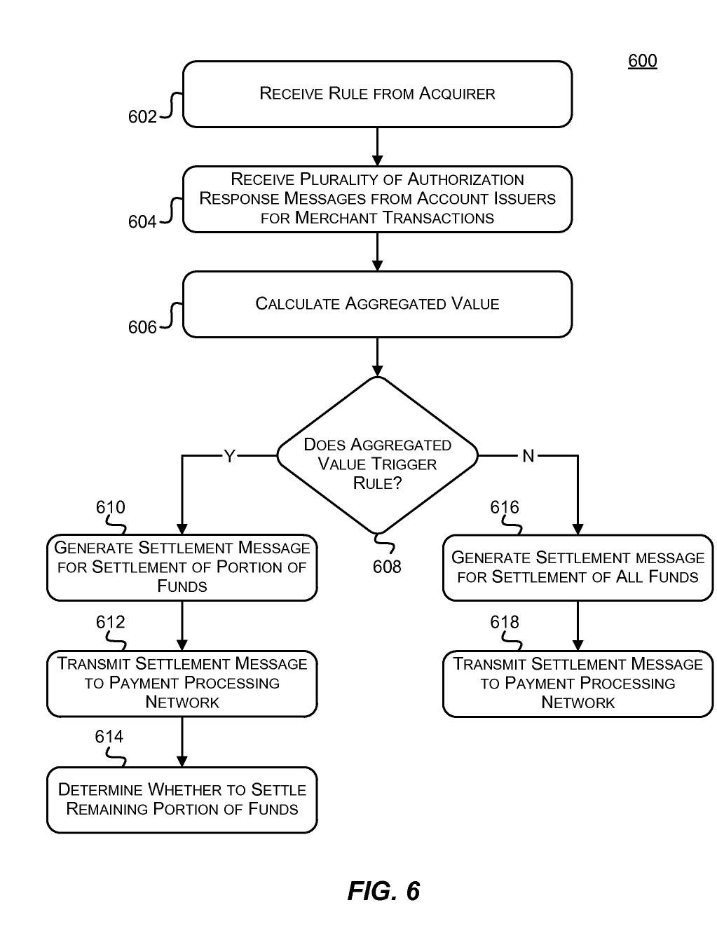

As described above, in some embodiments, the plurality of authorization messages received by the server computer can be authorization response messages received from issuers of accounts used to conduct the corresponding transactions. FIG. 6 shows a flowchart illustrating an exemplary method 600 of processing authorization response messages using acquirer rules in accordance with some embodiments.

In FIG. 6, at step 602, a server computer receives a rule from an acquirer, the rule to be applied to transactions conducted with a merchant. For instance, the server computer 202 of gateway 112 can receive a rule from the acquirer computer 114 to be applied to transactions conducted with the merchant computer 110. In some embodiments, the acquirer can provide the rule using an interface such as a web-based dashboard. The rule may include criteria that, if met, results in settlement of the corresponding transaction amount to be delayed for a predetermined period of time or until receiving acquirer approval to release the settlement.

As described above in regard to step 302 of method 300 and step 402 of method 400, the rule can include any criteria suitable for detecting or otherwise reducing the incidence of merchant fraud. In some embodiments, the rule received from the acquirer is to be applied to transactions conducted specifically with the merchant. In some embodiments, the rule received from the acquirer is to be applied to transactions conducted with a specified category of merchant (e.g., an MCC classification), the merchant being included in the specified category. The rule can include criteria that relates to a plurality (e.g., an aggregation) of transactions or, in some embodiments, to characteristics of individual transactions.

At step 604, the server computer receives a plurality of authorization response messages from issuers of accounts used to conduct the corresponding transactions, the plurality of authorization response messages indicating whether the corresponding transactions are authorized by the issuers. For instance, the server computer 202 of gateway 112 can receive a plurality of authorization response messages for multiple transactions from the issuer computer 118 (and other issuers in some embodiments) over a period of time.

At step 606, the server computer calculates an aggregate value based on transaction data included in the plurality of authorization response messages. In some embodiments, the aggregate value includes a sum of transaction amounts, a sum of transaction amounts in a time interval, and/or a number of transactions in a time interval. For instance, the server computer 202 of gateway 112 can retrieve transaction data from the transaction database 230 for a plurality of authorization response messages corresponding to merchant transactions approved by the issuer, and can calculate a value based on an aggregation of the transaction data.

At decision 608, the server computer determines whether the aggregate value triggers the rule. For instance, the server computer 202 of gateway 112 can compare the calculated aggregate value to criteria included in the rule to determine whether the rule is triggered. If the rule is triggered, the method 600 can proceed to step 610 where a transaction corresponding to an authorization request message in the plurality of authorization request messages is processed in accordance with a first protocol.

At step 610, in accordance with the first protocol, a settlement message is generated that requests only a portion of funds associated with the corresponding transactions to be transferred from the issuers to the acquirer. In some embodiments, the settlement request message can be generated in response to receiving a settlement request from the merchant, a time of day scheduled for settlement, expiration of a predetermined period of time, or other suitable trigger. In some embodiments, the settlement message can request settlement of only a subset of the issuer-approved merchant transactions. In other embodiments, the settlement message can request settlement of all the approved transaction but for only a portion of the aggregated transaction amount. For instance, at step 610, the server computer 202 of gateway 112 can generate a settlement message that requests that only a portion of funds associated with transactions conducted with the merchant be transferred from the issuer computer 118 (and other issuers in some embodiments) to the acquirer computer 114.

At step 612, the transfer of the portion of funds is initiated by transmitting the settlement message to a payment processing network. For instance, the server computer 202 of gateway 112 can transmit the settlement message to the payment processing network 116. The payment processing network 116 may then facilitate the transfer of the portion of funds for the merchant transactions from the issuer computer 118 (and other issuers in some embodiments) to the acquirer computer 114.

At step 614, it can be determined at a later time whether to initiate a transfer of the remaining portion of the funds from one or more of the issuers to the acquirer. In some embodiments, the acquirer rule may require that a predetermined period of time expire without the unsettled merchant transactions being reported or otherwise identified as fraudulent. Upon expiration of such a time period, the transfer of the remaining portion of the funds can be initiated. In some embodiments, the rule may require that the acquirer review the unsettled transactions (e.g., via a web-based dashboard) to determine whether one or more of the transactions are indicative of merchant fraud. In some embodiments, the acquirer can communicate with the merchant to determine why the acquirer's rule was triggered by the merchant's transactions. After receiving approval from the acquirer, in some embodiments, the settlement of the remaining portion of the funds can be initiated.

If the rule is not triggered at decision 608, the method 600 can instead proceed to step 616 where the transaction is processed in accordance with a second protocol. At step 614, a settlement message is generated requesting that funds (e.g., all the funds) associated with the corresponding transactions be transferred from the issuers to the acquirer. As with the first protocol, the settlement request message can be generated in response to receiving a settlement request from the merchant, a time of day scheduled for settlement, expiration of a predetermined period of time, or other suitable trigger. For instance, at step 614, the server computer 202 of gateway 112 can generate a settlement message that requests that all funds associated with transactions conducted with the merchant that day be transferred from the issuer computer 118 (and other issuers in some embodiments) to the acquirer computer 114.

At step 618, the transfer of the funds is initiated by transmitting the settlement message to the payment processing network. For instance, the server computer 202 of gateway 112 can transmit the settlement message to the payment processing network 116. The payment processing network 116 may then facilitate the transfer of the funds for the merchant transactions from the issuer computer 118 (and other issuers in some embodiments) to the acquirer computer 114.

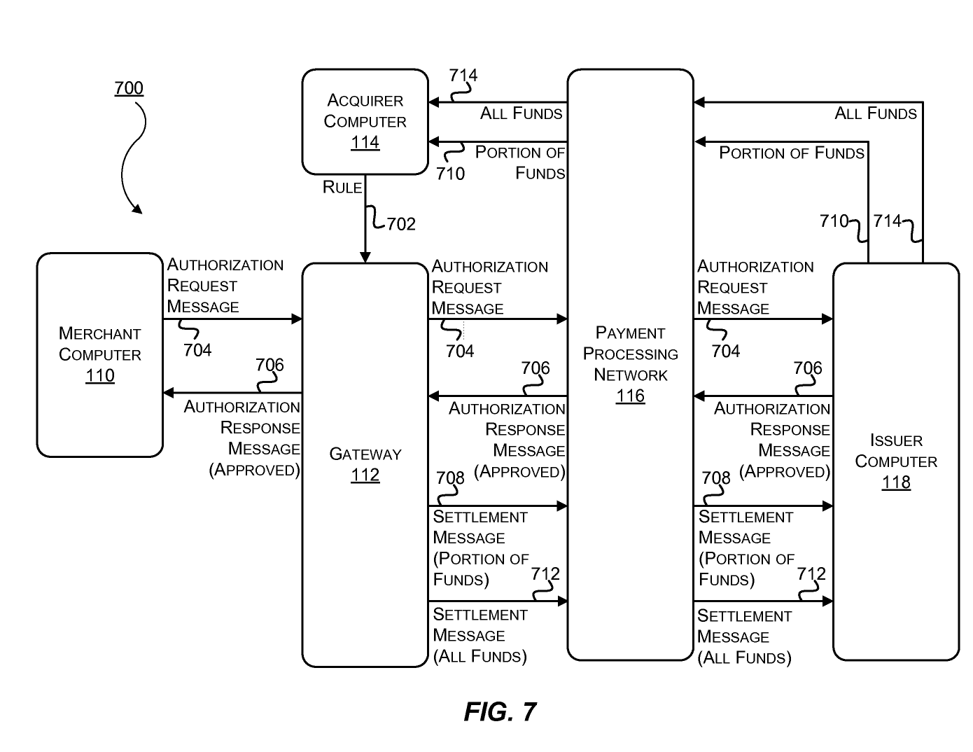

FIG. 7 shows a system 700 and corresponding workflow for processing authorization response message using acquirer rules in accordance with some embodiments. As illustrated in FIG. 7, the system 700 may include components of the system 100 shown in FIG. 1, such as the merchant computer 110, gateway 112, payment processing network 116, issuer computer 118, and acquirer computer 114.

As a non-limiting illustration using the system 700 and workflow shown in FIG. 7, the acquirer using the acquirer computer 114 can transmit a message 502 including a rule to the gateway 112. In this illustration, based on the merchant's average daily sales volume, the acquirer-provided rule can include criteria stating that when the daily sales volume has reached $300,000, settlement of any further transactions for that day must be delayed until the acquirer has an opportunity to review and approve settlement of the transactions.

At some point in time after receiving the rule from the acquirer computer 502, the gateway 112 may receive an authorization request message 704 from the merchant computer 110 for a transaction in the amount of $50,000. Upon receipt, the gateway 112 can forward the authorization request message 704 to the issuer computer 118 via the payment processing network 116. The issuer computer 118 may approve the transaction and transmit an authorization response message 706 indicating the approval to the gateway 112 via the payment processing network 116. The gateway can forward the authorization response message 706 to the merchant computer 110, thereby informing the merchant of the approval.

In this illustration, when the authorization response message 706 for the $50,000 transaction is received, the gateway 112 may have already received authorization response messages approving other transactions that total in the aggregate $300,000 for the day. Thus, at the end of the day when the gateway 112 may typically initiate settlement, the transaction corresponding to the authorization response message 706 will trigger the acquirer-provided rule that requires delayed settlement for the merchant's transactions after $300,000. Since the rule was triggered, the gateway can transmit a settlement message 708 to the payment processing network 116 for the transactions with an aggregated transaction amount of $300,000 but not for the $50,000 transaction approved after the threshold was met. The payment processing network 116 can forward the settlement message 708 to the issuer computer 118 which can in turn transmit the portion of the funds 710 (i.e. $300,000) to the acquirer computer 114 via the payment processing network 116. The acquirer can later review the $50,000 transaction for which settlement has been delayed to determine whether it is associated with merchant fraud, and can either instruct the gateway 112 to initiate settlement of the transaction or, alternatively, can cancel the transaction by instructing the gateway 112 not to initiate settlement. In some embodiments, a transaction may be automatically canceled if it is not settled within a predetermined period of time after issuer authorization (e.g., 30 days, 2 weeks, etc.).

If, however, the gateway 112 determines when the authorization request message 706 is received that the merchant's authorized transactions for the day only sum to $200,000, this will not trigger the rule. In this scenario, the gateway 112 can transmit a settlement message 712 to the payment processing network 116 for the full transaction amount for the day (e.g., $250,000). The payment processing network 116 can forward the settlement message 708 to the issuer computer 118 which can in turn transmit the full amount 714 to the acquirer computer 114 via the payment processing network 116.

Accordingly, when an acquirer-provided rule is triggered, the gateway 112 can delay settlement of a portion of funds associated with a merchant transaction. This provides an opportunity for the acquirer to review potentially fraudulent transactions and may also allow consumers an opportunity to identify and report merchant fraud or for merchant fraud to be otherwise detected.

### IV. Acquirer Rules

Embodiments of the invention may allow acquirers to set any suitable rules designed to detect or otherwise reduce the incidence of merchant fraud. Suitable rules may include, but are not limited to, declining authorization or delaying settlement when:
the total transaction volume (e.g., the number of attempted and/or issuer approved transactions) in a given time interval (e.g., hours, day, week, month, year, etc.) exceeds a threshold value
the total sales volume (e.g., the aggregate transaction amount) in a given time interval (e.g., hours, day, week, month, year, etc.) exceeds a threshold value
the total number of reversals, refunds, or voids in a given time interval (e.g., hours, day, week, month, year, etc.) exceeds a threshold value
an individual transaction amount exceeds a threshold value
the payment account used to conduct the transaction has a bank identification number (BIN) that falls within a range or list of specified BINs
the payment account used to conduct the transaction was issued in a particular country
the merchant conducted the transaction in a particular country
the payment account used to conduct the transaction is associated with a particular card brand
the payment account used to conduct the transaction is of a particular type (e.g., credit, debit, commercial, prepaid, gift, etc.)
the transaction is associated with a particular level of authentication (e.g., ECI value)
the transaction is associated with a particular transaction environment (e.g., card present, card not present, etc.)
the merchant or consumer initiated the transaction using a specified internet protocol (IP) address
   Any other suitable rule can be utilized according to various embodiments of the invention.

In some embodiments, acquirers can assign different rules to different types of merchants. For instance, as described above, merchants may each be assigned an MCC or other classifier that identifies the type of goods or services provided by the merchant. Since certain types of goods and services may be more likely to be involved in fraudulent transactions than others, acquirers can assign rules to specific merchant MCCs or other merchant categories. Similarly, acquirers can assign rules based on the length of time the merchant has been conducting transactions and their fraud history. For instance, a first set of rules can be assigned to merchants that are new (e.g., conducting transactions for less than one year, one month, etc.), a second set of rules can be assigned to merchants that have displayed some evidence of fraudulent behavior, and a third set of rules can be applied to merchants that have conducted transactions for a long period of time and/or which the acquirer has had a long-standing relationship.

In some embodiments, default rules can be created (e.g., by a gateway) to assist acquirers with reducing merchant fraud. Default rule criteria can take into account a number of different factors such as MCC classifications, the type of goods or services sold in view of historical fraud rates associated with such goods or services, the length of time a merchant has been conducting transactions, indications of past fraudulent behavior, or any other suitable factors describe herein. Such default rules may assist acquirers in scenarios where a new relationship has been formed with a merchant such that there is insufficient historical data available for the acquirer to establish rules of their own. After the acquirer works with the merchant for some time, the acquirer can modify the default rules to account for the specific transaction patterns and behavior of the merchant.

### V. Reserve Management

In some embodiments, of the invention, reserve management functionalities can be provided to acquirers. When an acquirer establishes a relationship with a merchant, the acquirer may set a “reserve limit” for the merchant. The reserve limit may be an amount that is held by the acquirer such that no funds are transferred by the acquirer to the merchant's bank account until the acquirer has received funds for the merchant's transactions in excess of the reserve limit. Generally, only funds above the reserve limit are released to the merchant, and the reserve limit can be maintained going forward such that a reserve amount is always held by the acquirer. The reserve limit may help protect the acquirer against liabilities associated with merchant fraud.

The initial reserve limit amount can be determined by the acquirer by considering a number of available factors about the merchant such as expected sales and transaction volume, average sale amount, the merchant category (e.g., MCC), the particular goods and/or services provided by the merchant, the length of time the merchant has been conducting transactions, the location of the merchant, any evidence of past merchant fraud, and other factors. However, one or more of these factors may change over time for the merchant such that the reserve limit may be unnecessarily low or high.

In some embodiments, merchant transactions can be monitored and analyzed over time. For instance, as illustrated in FIG. 2, information about a merchant's transactions can be stored in the transaction database 230, and periodically (or on demand) analyzed by the server computer 202 of the gateway 112. By regularly reviewing information about the merchant's transactions, changes in factors that may affect the merchant's reserve limit can be identified. Such information can be provided to acquirers in the form of reports or alerts which may allow acquirers to adjust the merchant's reserve limit accordingly. As an example, as the merchant conducts transactions over time with a low incidence of fraud, the acquirer can be made aware of this information in the form of a report (e.g., on a web-based dashboard) and may reduce the merchant's reserve limit. Alternatively, if there is a sudden increase in the number of chargebacks for the merchant, an alert or report can be sent to the acquirer which may in response increase the merchant's reserve limit. In some embodiments, the acquirer can provide guidelines regarding reserve management recommendations. For instance, the acquirer may ask that notifications be provided only when a merchant demonstrates a specific type of change in behavior, when certain metrics changes by a specified amount over a specified period of time, etc.

Accordingly, by making acquirers aware of merchant transaction trends and other changes in merchant characteristics and behavior, acquirers may be better equipped to set a merchant's reserve limit at an amount that accounts for the current status of the merchant.

### VI. Reporting

As described above, acquirers may be provided reports indicating various changes in merchant transactions and behavior which can be used by the acquirer to fine tune the merchant's reserve limit. In some embodiments, reports may also be provided to acquirers that include information about aggregated or individual transactions that trigger the acquirer-provided rules described herein. In some transaction environments (e.g., e-commerce), the acquirer may only be aware of transactions that are both authorized and settled. Since an authorization request message rejected by the gateway will not be passed on to the issuer for authorization, no settlement will occur between the issuer and acquirer, and thus the acquirer may be unaware that the merchant attempted the transaction. Similarly, in some embodiments, acquirers may not be aware of transactions for which settlement has been delayed when the transaction is reported by the consumer as fraudulent prior to expiration of the delay period. By providing acquirers with reports including details about transactions that are rejected (or for which settlement has been delayed) by the gateway, acquirers may be better able to adjust the rules established at the gateway to reduce “false positives” while preventing fraudulent transactions from being authorized and settled.

In some embodiments, the merchant transaction trends and behavior changes described above with respect to reserve limits may also be useful to acquirers for purposes of adjusting the rules established at the gateway. Information about changes in merchant sales, transaction volume, average sale amount, MCC, goods and/or services, age, location, and other metrics can be reported to and utilized by acquirers to fine tune their fraud-detection rules.

Acquirers can be provided reports that include any suitable information about individual merchants or groups of merchants. Such information can include, but is not limited to:
merchants with a sales volume that has exceeded a limit in a given time interval (e.g., daily, weekly, monthly, etc.)
merchants with refunded transactions and credits that exceed a threshold percentage or amount of the merchants' transactions in a given time interval (e.g., daily, weekly, monthly, etc.)
merchants with a periodic (e.g., daily, weekly, monthly, etc.) settlement amount that is zero or negative (e.g., when the merchants' credits exceed sales)
merchants with a periodic (e.g., daily, weekly, monthly, etc.) settlement amount greater than a threshold value, and that received a first deposit of funds from the acquirer greater than a specified time interval (e.g., 30 days) after establishing the relationship with the acquirer
merchants with individual transactions some multiple (e.g., 5×) greater than their average transaction amount
merchants with authorization requests for individual transactions less than a threshold amount (e.g., $1) in a volume greater than a default number of transactions (e.g., five) in a given interval of time (e.g., one day)
merchants with authorization declines above some threshold percentage (e.g., 15%) of the merchants' transactions
merchants that have “forced authorizations” where the transaction authorization request is saved and submitted to the gateway in a batch authorization file
merchants that have processed credits with no corresponding initial purchase transaction
merchants that received a first deposit of funds from the acquirer within a given interval of time (e.g., the last 60 days).
merchants that have experienced a decrease in transaction volume in an interval of time (e.g., day, week, month, etc.) as compared to a previous interval of time (e.g., yesterday, last week, last month, etc.), the change being greater than a threshold percentage (e.g., 35%)
merchants that have processed their first transaction
   Any other suitable reports can be generated and provided to an acquirer according to various embodiments of the invention. The reports described herein (and other suitable reports) can be provided to acquirers for purposes of calibrating fraud detection rules, adjusting reserve limits, and any other suitable purpose.

### VII. Computer Apparatus

The various participants and elements described herein with reference to FIGS. 1-7 may operate one or more computer apparatuses to facilitate the functions described herein. Any of the elements in FIGS. 1-2, including any servers or databases, may use any suitable number of subsystems to facilitate the functions described herein.

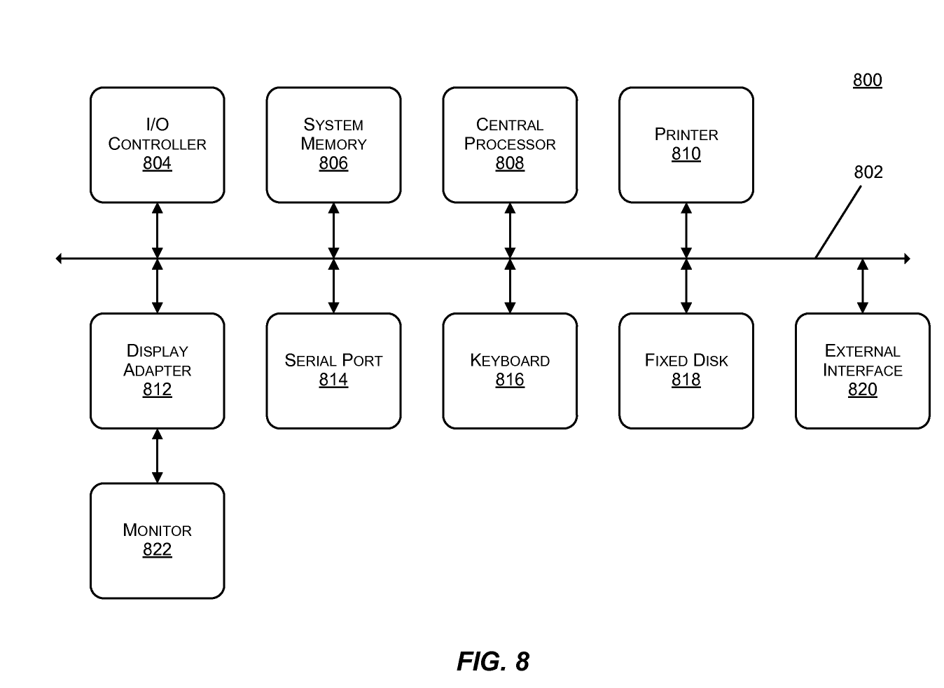

Examples of such subsystems or components are shown in FIG. 8 which illustrates exemplary computer apparatus 800. The subsystems shown in FIG. 8 are interconnected via a system bus 802. Additional subsystems such as a printer 810, keyboard 816, fixed disk 818 (or other memory comprising computer readable media), monitor 822, which is coupled to a display adapter 812, and others are shown. Peripherals and input/output (I/O) devices, which couple to I/O controller 804 (which can be a processor or other suitable controller), can be connected to the computer system by any number of means known in the art, such as a serial port 814. For instance, serial port 814 or an external interface 820 can be used to connect computer apparatus 800 to a wide area network such as the Internet, a mouse input device, or a scanner. The interconnection via system bus 802 allows a central processor 808 to communicate with each subsystem and to control the execution of instructions from a system memory 806 or fixed disk 818, as well as the exchange of information between subsystems. System memory 806 and/or fixed disk 818 may embody a computer readable medium.

Further, while the present invention has been described using a particular combination of hardware and software in the form of control logic and programming code and instructions, it should be recognized that other combinations of hardware and software are also within the scope of the present invention. The present invention may be implemented only in hardware, or only in software, or using combinations thereof.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method comprising:
receiving, by a server computer, a rule from an acquirer, the rule to be applied to transactions conducted with a merchant;
receiving, by the server computer, a plurality of authorization messages, each of the plurality of authorization messages corresponding to a different transaction conducted with the merchant;
calculating, by the server computer, an aggregate value based on transaction data included in the plurality of authorization messages;
determining, by the server computer, whether the aggregate value triggers the rule;
if the aggregate value triggers the rule, processing a transaction corresponding to an authorization message in the plurality of authorization messages in accordance with a first protocol; and
if the aggregate value does not trigger the rule, processing the transaction in accordance with a second protocol.

2. The method of claim 1, wherein the plurality of authorization messages are authorization request messages received from the merchant.

3. The method of claim 2, wherein processing the transaction in accordance with the first protocol comprises:
generating an authorization response message, the authorization response message indicating that authorization of the transaction is declined; and
transmitting the authorization response message to the merchant.

4. The method of claim 2, wherein processing the transaction in accordance with the second protocol comprises:
transmitting the authorization request message to an issuer of an account used to conduct the transaction;
receiving an authorization response message from the issuer, the authorization response message indicating whether the transaction is authorized by the issuer; and
transmitting the authorization response message to the merchant.

5. The method of claim 1, wherein the plurality of authorization messages are authorization response messages received from issuers of accounts used to conduct the corresponding transactions, the plurality of authorization response messages indicating whether the corresponding transactions are authorized by the issuers.

6. The method of claim 5, wherein processing the transaction in accordance with the first protocol comprises:
generating a settlement message requesting that only a portion of funds associated with the corresponding transactions be transferred from the issuers to the acquirer;
initiating the transfer of the portion of funds by transmitting the settlement message to a payment processing network; and
determining, at a later time, whether to initiate a transfer of the remaining portion of the funds from one or more of the issuers to the acquirer.

7. The method of claim 5, wherein processing the transaction in accordance with the second protocol comprises:
generating a settlement message requesting that funds associated with the corresponding transactions be transferred from the issuers to the acquirer; and
initiating the transfer of funds by transmitting the settlement message to a payment processing network.

8. The method of claim 1, wherein the rule received from the acquirer is to be applied to transactions conducted at a specified category of merchants, and wherein the merchant is included in the specified category.

9. The method of claim 1, wherein the aggregate value includes one or more values selected from the group consisting of: a sum of transaction amounts, a sum of transaction amounts in a time interval, and a number of transactions in a time interval.

10. A server computer comprising:
a processor; and
a computer-readable medium coupled to the processor, the computer-readable medium including code executable by the processor for performing a method comprising:
receiving a rule from an acquirer, the rule to be applied to transactions conducted with a merchant;
receiving a plurality of authorization messages, each of the plurality of authorization messages corresponding to a different transaction conducted with the merchant;
calculating an aggregate value based on transaction data included in the plurality of authorization messages;
determining whether the aggregate value triggers the rule;
if the aggregate value triggers the rule, processing a transaction corresponding to an authorization message in the plurality of authorization messages in accordance with a first protocol; and
if the aggregate value does not trigger the rule, processing the transaction in accordance with a second protocol.

11. The server computer of claim 10, wherein the plurality of authorization messages are authorization request messages received from the merchant, and wherein processing the transaction in accordance with the first protocol comprises:
generating an authorization response message, the authorization response message indicating that authorization of the transaction is declined; and
transmitting the authorization response message to the merchant.

12. The server computer of claim 10, wherein the plurality of authorization messages are authorization request messages received from the merchant, and wherein processing the transaction in accordance with the second protocol comprises:
transmitting the authorization request message to an issuer of an account used to conduct the transaction;
receiving an authorization response message from the issuer, the authorization response message indicating whether the transaction is authorized by the issuer; and
transmitting the authorization response message to the merchant.

13. The server computer of claim 10, wherein the plurality of authorization messages are authorization response messages received from issuers of accounts used to conduct the corresponding transactions, wherein the plurality of authorization response messages indicate whether the corresponding transactions are authorized by the issuers, and wherein processing the transaction in accordance with the first protocol comprises:
generating a settlement message requesting that only a portion of funds associated with the corresponding transactions be transferred from the issuers to the acquirer;
initiating the transfer of the portion of funds by transmitting the settlement message to a payment processing network; and
determining, at a later time, whether to initiate a transfer of the remaining portion of the funds from one or more of the issuers to the acquirer.

14. The server computer of claim 10, wherein the plurality of authorization messages are authorization response messages received from issuers of accounts used to conduct the corresponding transactions, wherein the plurality of authorization response messages indicate whether the corresponding transactions are authorized by the issuers, and wherein processing the transaction in accordance with the second protocol comprises:
generating a settlement message requesting that funds associated with the corresponding transactions be transferred from the issuers to the acquirer; and
initiating the transfer of funds by transmitting the settlement message to a payment processing network.

15. The server computer of claim 10, wherein the rule received from the acquirer is to be applied to transactions conducted at a specified category of merchants, wherein the merchant is included in the specified category, and wherein the aggregate value includes one or more values selected from the group consisting of: a sum of transaction amounts, a sum of transaction amounts in a time interval, and a number of transactions in a time interval.

16. A method comprising:
transmitting, by an acquirer computer, a rule to a server computer, the rule to be applied to transactions conducted with a merchant, and wherein the server computer thereafter:
receives a plurality of authorization messages, each of the plurality of authorization messages corresponding to a different transaction conducted with the merchant;
calculates an aggregate value based on transaction data included in the plurality of authorization messages;
determines whether the aggregate value triggers the rule;
if the aggregate value triggers the rule, processes a transaction corresponding to an authorization message in the plurality of authorization messages in accordance with a first protocol; and
if the aggregate value does not trigger the rule, processes the transaction in accordance with a second protocol.

17. The method of claim 16, wherein the plurality of authorization messages are authorization request messages received from the merchant, and wherein processing the transaction in accordance with the first protocol comprises:
generating an authorization response message, the authorization response message indicating that authorization of the transaction is declined; and
transmitting the authorization response message to the merchant.

18. The method of claim 16, wherein the plurality of authorization messages are authorization request messages received from the merchant, and wherein processing the transaction in accordance with the second protocol comprises:
transmitting the authorization request message to an issuer of an account used to conduct the transaction;
receiving an authorization response message from the issuer, the authorization response message indicating whether the transaction is authorized by the issuer; and
transmitting the authorization response message to the merchant.

19. The method of claim 16, wherein the plurality of authorization messages are authorization response messages received from issuers of accounts used to conduct the corresponding transactions, wherein the plurality of authorization response messages indicate whether the corresponding transactions are authorized by the issuers, and wherein processing the transaction in accordance with the first protocol comprises:
generating a settlement message requesting that only a portion of funds associated with the corresponding transactions be transferred from the issuers to the acquirer;
initiating the transfer of the portion of funds by transmitting the settlement message to a payment processing network; and
determining, at a later time, whether to initiate a transfer of the remaining portion of the funds from one or more of the issuers to the acquirer.

20. The method of claim 16, wherein the plurality of authorization messages are authorization response messages received from issuers of accounts used to conduct the corresponding transactions, wherein the plurality of authorization response messages indicate whether the corresponding transactions are authorized by the issuers, and wherein processing the transaction in accordance with the second protocol comprises:
generating a settlement message requesting that funds associated with the corresponding transactions be transferred from the issuers to the acquirer; and
initiating the transfer of funds by transmitting the settlement message to a payment processing network.
